(19) United States
(12) Patent Application Publication
(10) Pub. No.: US 2003/0191558 A1
(43) Pub. Date: Oct. 9, 2003

(54) Beverage dispensing system

(76) Inventor: Martin Arellano, Garden City, NY (US)

Correspondence Address: FISH & RICHARDSON P.C., 45 ROCKEFELLER PLAZA, SUITE 2800, NEW YORK, NY, 10111, US

(21) Appl. No.: 10/102,473

(22) Filed: Mar. 20, 2002

(51) Int. Cl. G06F 17/00

(52) U.S. Cl. 700/237

(57) ABSTRACT

A method and apparatus for receiving beverage consumption information over a communications path and producing beverage configuration information based on the beverage consumption information. The beverage configuration information which is to be used for configuring a beverage dispensing device is sent over the communications path.

### BACKGROUND

This invention relates to a beverage dispensing system.

Traditional beverage distribution business models involve a bottling company producing beverages and then distributing the beverages through wholesale and retail channels. A consumer would then make small quantity beverage purchases through the wholesale and retail channels. It was believed not cost effective to deliver beverages directly to the consumer because of a low delivery density which may characterize the consumer distribution channel. Moreover, gathering beverage consumption information from consumers has often been difficult making future consumption delivery decisions prone to error.

### SUMMARY

In one aspect, the invention provides a method for receiving beverage consumption information over a communications path and producing beverage configuration information based on the beverage consumption information. The beverage configuration information which is to be used for configuring a beverage dispensing device is sent over the communications path.

In one embodiment, the method may include receiving a beverage configuration information request over the communications path, retrieving beverage consumption information previously stored, and sending a beverage configuration information response over the communications path for configuring the beverage dispensing system, wherein the beverage configuration information response is based on the retrieved beverage consumption information.

In another embodiment, the communications path may include a network. The consumption information may include an expected beverage usage during a period of time. The beverage configuration information may include at least one of a beverage quantity, password protection for the beverage as installed in the beverage dispensing device, and beverage delivery information.

In a second aspect, the invention includes an apparatus configured to operate according to the method disclosed above.

In a third aspect, the invention includes an article comprising a computer-readable medium that stores computer-executable instructions for causing a computer system to perform the method disclosed above.

In a fourth aspect, the invention provides a method of monitoring usage of a beverage in a beverage dispensing device, producing a beverage configuration information request in response to having the level of the beverage in the beverage dispensing device reach a predetermined threshold level, sending the beverage configuration information request over a communications path, and receiving a beverage configuration information response for configuring the beverage dispensing device.

In one embodiment, the beverage configuration information request maybe sent as an Email signal or a wireless signal, to an authorized user of the beverage dispensing device. The communications path may include a network. The configuration information response may include a password to control access to a beverage in the beverage dispensing device. The configuration information response may also include a predetermined threshold level that when reached causes the beverage configuration information request to be produced. Also, the beverage configuration information may include beverage dispensing data.

In a fifth aspect, the invention includes an apparatus configured to operate according to the method disclosed above.

In a sixth aspect, the invention includes an article comprising a computer-readable medium that stores computer-executable instructions for causing a computer system to perform the method disclosed above.

The foregoing techniques can help reduce the cost of operating a consumer or business distribution channel by increasing the delivery density of delivering beverages to a consumer or business entity. The information infrastructure, which includes gathering beverage consumption from users maybe used by various beverage related entities such as bottlers, wholesalers, and retailers to improve sales into this distribution channel. The beverage related entities could leverage their current distribution infrastructure with the information infrastructure according to the invention to increase profits through improved sales over the distribution channel. The techniques allow the automatic reordering of beverages when they have reached a predetermined level which have been previously established by the user. This automatic ordering techniques can allow the beverage related entities to optimized delivery times and dates resulting in reduced transportation costs. More importantly, the beverage related entities may now have the capability of having marketing information about consumer consumption habits permitting the entities to focus advertising and marketing efforts to actual consumption habits and behavior.

In addition, the foregoing techniques may provide a user of a beverage dispensing device with increased flexibility and control over the beverage dispensing system. The user maybe able to control access to each beverage in the dispenser through the use of password protection techniques such as an alphanumeric passwords, access control cards, or other password protection techniques. The user is also able to update the configuration information at the server over a communications path such technology ranging from an Internet connection using a conventional personal computer (PC) to a personal digital assistant (PDA) using wireless techniques. A user of the dispenser may also benefit from reduction in beverage delivery services which is made possible by the consumption information gathered and managed by the server. The information includes information related to each user which can be used by third parties such as the beverage delivery entities to optimize delivery routes resulting in reduced transportation costs which may be passed onto the user.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a block diagram of a beverage dispensing system in accordance with the invention.

FIG. 2 is a block diagram of a beverage dispensing device in accordance with the invention.

FIG. 3 is a block diagram of a beverage system server computer in accordance with the invention.

FIG. 4 is a flow chart of a method of operating a beverage dispensing device in accordance with the invention.

FIG. 5 is a flow chart of a method of operating a beverage dispensing server computer in accordance with the invention.

Like reference symbols in the various drawings indicate like elements.

### DETAILED DESCRIPTION

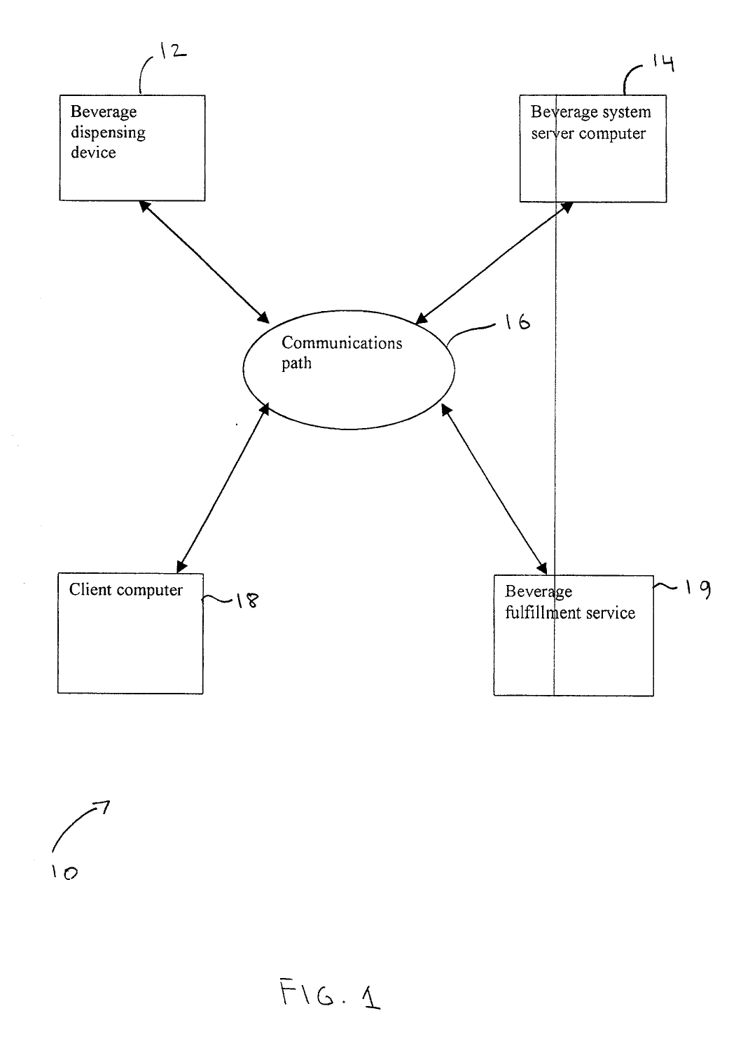

As shown in FIG. 1, a beverage dispensing system 10 includes a beverage dispensing device (“the dispenser”) 12 capable of dispensing multiple beverages from multiple beverage containers. The dispenser 12 communicates with a beverage system server computer (“the server”) 14 over a communications path 16. A user such as a residential or commercial consumer can request to purchase or acquire a dispenser 12 by using a client computer 18 to send beverage consumption information to the server 14 over the communications path 16.

The beverage consumption information is used by the server 14 to produce beverage configuration information which can be utilized to configure the dispenser 12. The server 14 communicates this information to a beverage fulfillment service 19 which can use the information to fulfill any beverage requirements of the dispenser 12 such as delivering a refilled beverage container. The operation of the beverage dispensing system 10 is discussed in further detail below.

The communications path 16 can be implemented using a network such as the Internet, wide-area-network (WAN), local-area-network (LAN), or other network. The path 16 also can be implemented using wireless techniques such as cellular digital packet data (CDPD), wireless application protocol (WAP), Bluetooth, or other wireless techniques. In addition, the communications path 16 can be implemented using wired communications techniques such as cable-modem, analog modem, digital subscriber line (DSL), or other wired techniques. The communications path 19 also can employ secured transmission techniques such as secured socket layer (SSL), private key infrastructure (PKI), and encryption methods, or other secure techniques.

The client computer 18 can be implemented using a computing device capable of communicating with the server 14. Such a computing device can be a personal computer (PC) configured to communicate over the communications path 16 such as the Internet or the World-Wide-Web (“Web”). The computing device can be adapted with a communications program such as a Web-browser so that a user can access a Web-site provided by the server 14. The Web-site can allow the user to view information provided by the server. This information can include information associated with purchasing a beverage dispensing system. For example, the user can provide the Web-site with beverage consumption information including the type and amount of beverages consumed, the number of persons in the household, and the preferred time and date for beverage delivery, and other information. In response, the server can produce beverage configuration information which represents a recommendation based on various factors including the beverage consumption information received from the user. In addition, the client computer can view the status of the account, make payment, or view beverage consumption information.

The client computer 18 can have electronic mail (Email) capability so that it can receive information from other systems. For example, the beverage dispensing device 12 can monitor the level of each beverage and generate a beverage configuration information request when the level reaches a predetermined level. The request can be in the form of an Email. In addition, the server can user Email to send information to the client computer such as payment status, promotional, advertising, marketing information, or other information.

The beverage fulfillment service 19 can be, according to one embodiment, a business entity using a PC running a communications program to allow it to communicate with the server 14 over the communications path 16. The beverage fulfillment service is granted access to the information related to the dispenser such as beverage consumption information and beverage configuration information. This information gives the beverage fulfillment service the capability of providing order fulfillment services such as replenishing the beverages used by the dispenser 12 when the amount of beverage in the beverage container has reached a predetermined level indicating that replenishment is required. Replenishment can include physically removing empty beverage containers and replacing the empty containers with filled beverage containers. Once the beverages have been replenished, the beverage fulfillment service can request to have the beverage configuration information downloaded to the dispenser so that it can be configured according to the information.

The user can make payment to the beverage fulfillment service personnel for the replenishment service at the time the service is being rendered. Alternately, the user could arrange to pay for services on a periodic basis such as on a monthly basis. The server 14 can handle back office functions such as billing and accounts receivable such that the beverage fulfillment service can concentrate on gathering information from the server and simply deliver filled beverage containers to location of the dispenser.

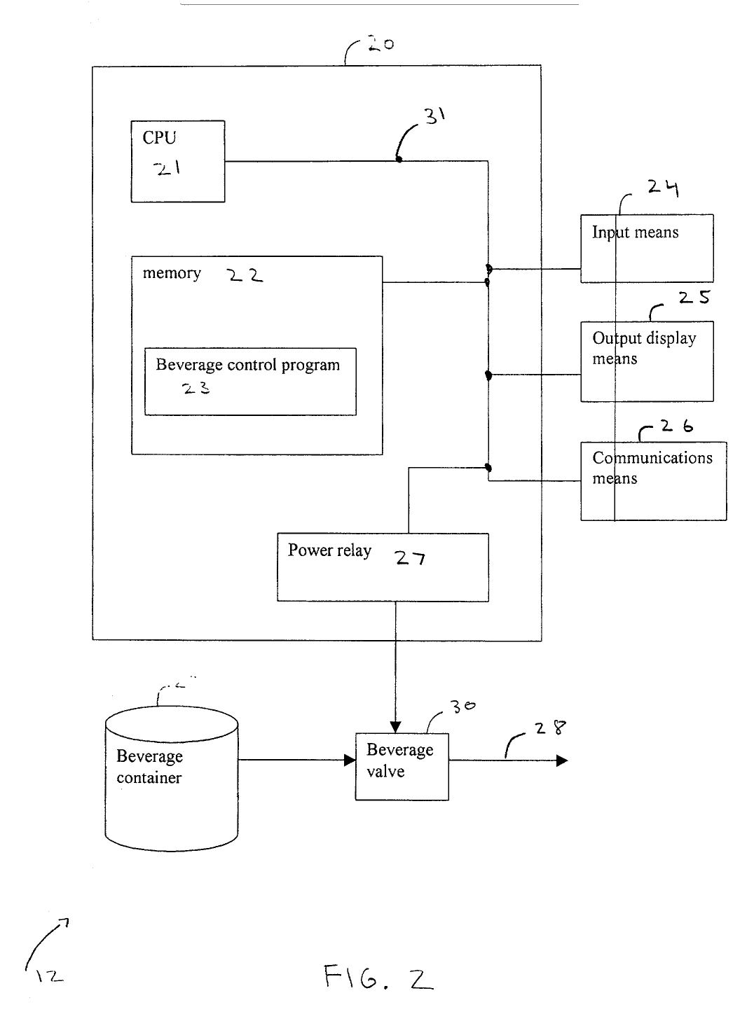

As shown in FIG. 2, the dispenser 12 includes a controller system 20 for controlling the operation of the dispenser. The controller system 20 comprises a central processing unit (CPU) 21 coupled to memory 22 through a system bus 31. The memory 22 can include static random access memory (SRAM), dynamic random access memory DRAM, read only memory (ROM), flash ROM, or other memory. The CPU 21, such as an Intel Pentium, processes data and programs residing in the memory 22. Such a program includes a beverage control program 23 containing software instructions for carrying out the functions of the operation of the dispenser 12.

The dispenser 12 can receive data from a user of the dispenser by an input means 24 such as a keyboard, touch screen display, wireless devices such as a personal data assistant (PDA), or other input means. Typically, the input means is used for inputting data such as beverage requests, password data for controlling access to the dispenser, a request to have an empty beverage container 29 replenished, or other data. Likewise, the dispenser 12 can output data for viewing through an output display means 25 such as a PDA, liquid crystal display (LCD), a printer, or other output means. The output data can include beverage configuration information such as status data indicating the amount of beverage remaining, usage information such as the time and dates when beverage dispensing occurred, or other data.

In addition, a communications means 26, which includes hardware and software components, can be configured to exchange information over the communications path 16 using several communications technologies, such as wireless means, as discussed above. The information that is exchanged can include beverage configuration information requests indicating the status of the dispenser such as that the amount in a beverage container has reached a predetermined level and that it is time to replenish the beverage container.

The beverage control program 23 includes instructions for controlling the dispensing of a beverage housed in a beverage container 29. The dispenser 12 can include multiple beverage containers 29 each containing a beverage which can be dispensed through a respective dispensing nozzle 28. The flow of the beverage can be controlled by a power relay 27 and a corresponding beverage valve 30. To dispense a beverage, the power relay 27 converts an activate signal having low power from the CPU 21 into a higher power signal adequate to open the beverage valve 30 allowing the flow of the beverage through the dispensing nozzle 28. In a similar manner, to halt the flow of the beverage, the CPU 21 removes the activate signal causing the power relay 27 to deactivate and the beverage valve 30 to close.

The dispenser 12 can process input data such as a request to dispense a particular beverage from a dispensing nozzle 28. The user may also be required to enter password information, which maybe validated by the beverage control program 23, to determine whether to proceed and accept the request to dispense the beverage. Moreover, the program 23 may contain instructions for determining the amount of pressure and the time duration necessary to dispense a beverage from a beverage container 29. In addition, the program 23 may include instructions for monitoring the amount of beverage in a beverage container and for generating a beverage configuration information request when the level reaches a predetermined level.

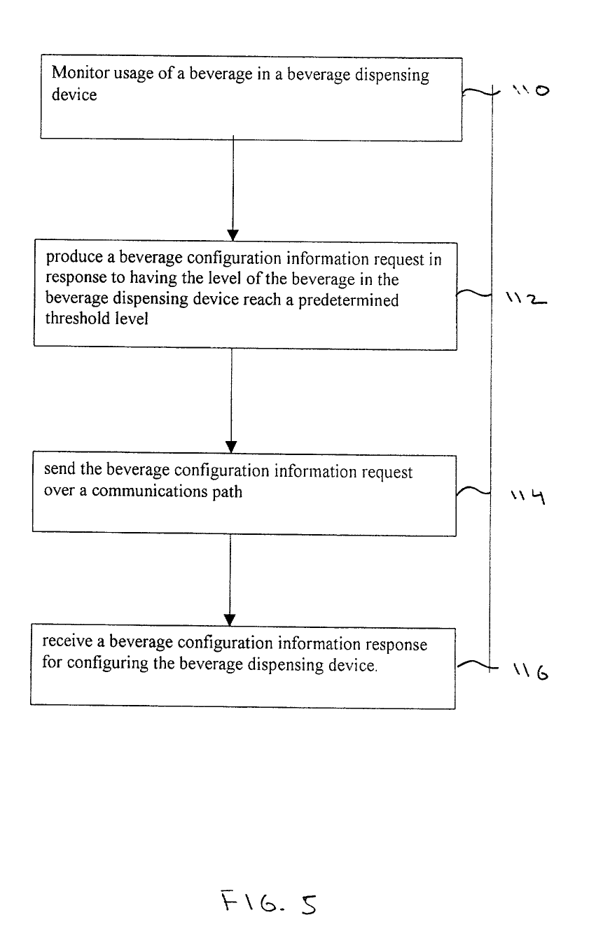

In addition, the dispenser 12 may include functionality to control the amount dispensed from a beverage container. This functionality can be derived from a combination of the beverage control program 23 in conjunction with criteria in beverage configuration information. For example, the beverage configuration information that is received from the server contains beverage dispensing criteria such as the amount in a full beverage container. It may also include a predetermined amount of beverage that when reached can trigger an alert signal such as a beverage configuration information request indicating that the predetermined amount has been reached. The program 23 can use the criteria to calculate during each dispensing action the amount dispensed which is accumulated and compared against the filled amount. Once the amount has been reached, the alert signal discussed above is produced. The operation of the dispenser 12 is discussed in further detail below with reference to FIG. 5.

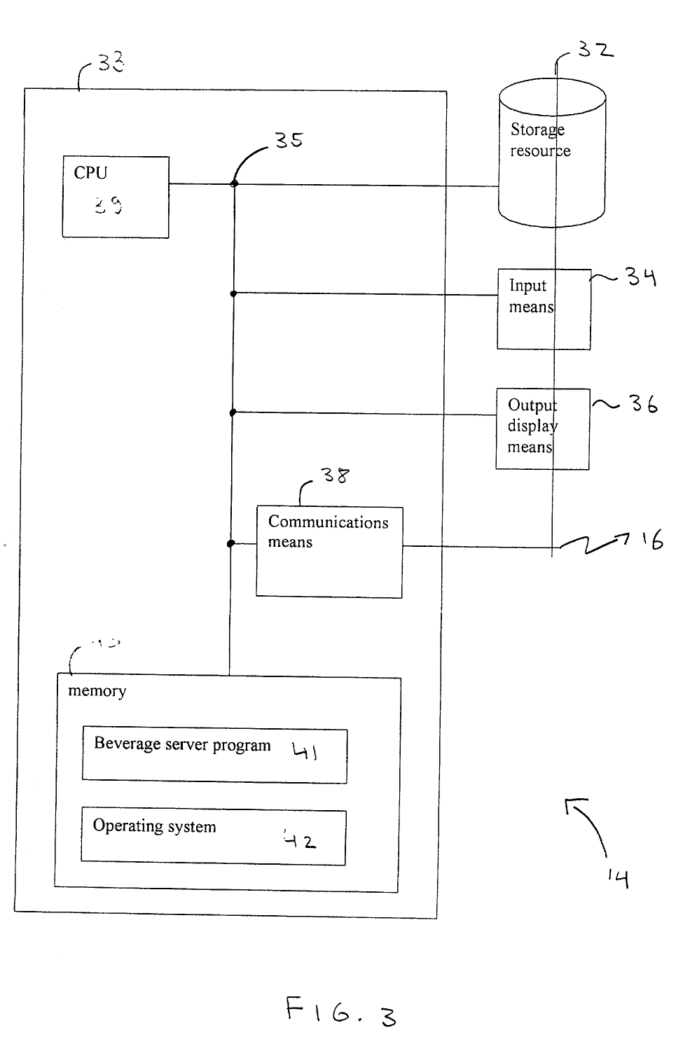

As shown in FIG. 3, the server 14 can be implemented as a computer 33 having a CPU 39 connected to memory 40 over a system bus 35. The CPU 39 processes data and programs residing in memory. Such a program can include a beverage server program 41 and an operating system 42 such as Windows NT, Linux, or other operating system. The operating system 42 in conjunction with the beverage server program 41 may provide the software resources and instructions for controlling the overall operation of the server 14. In particular, the beverage server program 41 manages business transaction related to the dispenser 14. Such business transactions include maintaining a Website infrastructure for permitting a user to input information to subscribe to services associated with purchasing the dispenser, allowing the user to update the information, generating recommended beverage configuration information such as the amount of beverage and the delivery schedule for the beverage, predetermined level data for generating an alert or reminder for replenishing the beverage. In addition, the beverage program 41 can manage business transactions with the fulfillment service 19 including handling the back office functions such as handling the payment transactions for the beverage service and forwarding information such as beverage configuration and consumption information containing data related to the user and associated dispenser. The operation of the beverage server program 41 is discussed in detail below with reference to FIG. 5.

The server 14 can include conventional input means 34 such as a keyboard, a mouse, or a floppy drive, and an output display means 36 such as a video display monitor and/or a printer. A communications means 38 may permit the server 14 to communicate over the communications path 16 with external systems such as multiple dispensers 12, multiple client computers 18, and multiple fulfillment service systems 19, or other external systems. As discussed above, the communications means 38 can accommodate communications technologies including wireless and wired means using a direct link or over a network.

In addition, the server 14 may be adapted to have a storage resource 32 such as long term storage including a hard disk drive, redundant array of inexpensive/independent disks (RAID), optical drives, or other storage resources. The storage resource 32 can be configured to contain a file system or databases for storing information associated with each dispenser 14 and user. This information can include beverage consumption information containing profile information about each user such as home/business/mailing address, beverage consumption, demographic data, or other information. In addition, the storage resource 32 can maintain beverage configuration information such as password data for authorizing usage to the dispenser 12. The information also can include predetermined level data specifying when and through which method an alert signal should be generated indicating when the amount of the beverage has reached the predetermined level.

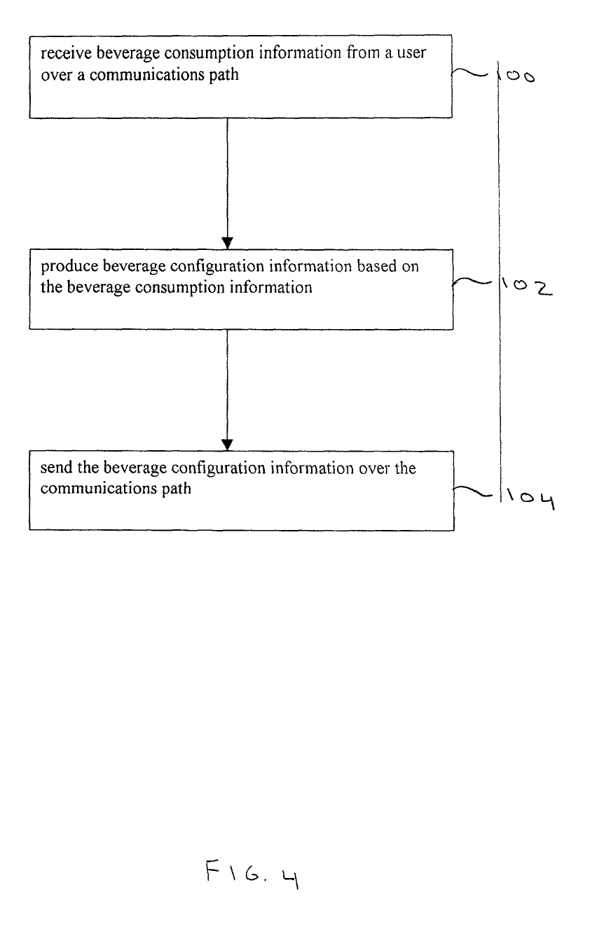

As shown in FIG. 4, the server 14 receives 100 beverage consumption information from a user utilizing, for example, a client computer 18 running a Web-browser, over a communications path 16. The user who maybe interested in acquiring a dispenser 12 can search the Internet for a Web-site provided by the server 14 and browse for information about the beverage dispensing services. Once the user decides to subscribe to the beverage dispensing service, the used can provide beverage consumption information such as an expected beverage usage or consumption during a period of time.

For example, the user may be interested in having a dispenser 12 configured to dispense 4 different beverages: (1) sparkling water from a first container, (2) beer from a second container, (3) orange juice from a third container, and (4) ginger ale from a fourth container. The user can also provide demographic information such as the number of persons in the household and the anticipated consumption amounts during a period of time such as one week. In addition, each container can be assigned a password such that only persons with the password will be allowed to dispense from a particular beverage container holding, for example, an alcoholic beverage.

Information related to when the dispenser is to be delivered as well as anticipated delivery and refill times for each beverage can be processed by the server 14. In addition, the user can select for each beverage a predetermined amount that when reached by each beverage a signal in the form of a beverage configuration information request is generated. The user can decide the different alerting means the signal can be communicated including Email, page alert, phone call reminder, or other alerting means. Methods of payments also can be established such as credit card billing arrangements, secured Internet payment schemes or other methods of payment.

Once the data is gathered from the user and combined into the beverage confirmation information, the server 14 produces 102 beverage configuration information based on the beverage consumption information and other criteria. For example, the server may recommend the delivery of a particular beverage container on a day that would cost less than the delivery arrangement originally desired by the user. This recommendation is based on information the server has created as a result of relationships with fulfillment services and various cost criteria such as whether the user is a consumer or business entity, the time and date of delivery, the amount of business the user has generated in the past which is based on the type, amount, and frequency of precious beverage orders.

Once the beverage configuration information has been produced, the server 14 sends 104 the beverage configuration information over the communications path 16. The information can be used for configuring the dispenser 12. The dispenser 12 processes the received information which can include password information for each beverage, the name of each beverage to be used to display the name of the beverage to the user, dispensing information such as amount/volume and pressure for dispensing each beverage.

Alternately, the server 12 can be configured to handle a beverage configuration information request from the communications path. In response, the server can retrieve the beverage configuration information previously stored and send a beverage configuration information response over the communications path. The request can originate from the dispenser 12 as a result of a beverage reaching a predetermined level.

In addition, the beverage configuration information can be forwarded to a fulfillment service 19 which can satisfy a beverage configuration request such as replenishing the beverage containers by delivering filled beverage container specified in the information. As discussed above, the server 14 can provide the fulfillment service 19 with business functions such as gathering the information from the user and handling the billing process. Moreover, it can provide data warehousing functionality such as storing the information for later analysis. This analysis includes customer relations marketing and distribution. For example, the information gathered could reveal trends which can be used to increase profits by improving the beverage delivery distribution channel.

As shown in FIG. 5, the dispenser 12 monitors 110 the usage of a beverage in the dispenser 12. The dispenser 12 produces and sends an initial beverage configuration information request to the server 14 when it is first installed. In response, the server 14 sends a beverage configuration response to the dispenser 12 which can be used by the dispenser to initialize the dispenser. As discussed above, the beverage configuration information response include password data to control access to a beverage in the beverage dispenser 12. In addition, the beverage configuration information includes a predetermined threshold level that when reached causes the beverage configuration information request to be produced. As discussed above, the amount of beverage dispensed is tracked during each dispense operation and the amount remaining can be compared to the original full amount in the beverage container 29.

The dispenser 12 produces 112 a beverage configuration information request in response to having the level of the beverage in the dispenser 12 reach a predetermined threshold level. In one embodiment, the request can be an Email or a wireless signal sent to an authorized user of the beverage dispenser 12. The authorized user can include the person responsible for making payments for the dispenser 12 or some other person who has been given authority. This may help prevent unauthorized transactions from taking place. The user has the option of configuring the dispenser to automatically generate the request without any intervention. In addition, the dispenser 12 can be configured to generate a request to the user through the output means 25 as shown in FIG. 2.

In another embodiment, the dispenser 12 can provide the user with the opportunity to review the configuration information before it sent to the server 14. This allows the user to modify the request by changing, for example, the amount or type of beverage to be delivered which may reduce the cost of the next beverage delivery transaction. For example, the dispenser 12 may alert the user that a particular beverage has reached the predetermined level and that it needs to be ordered. The dispenser 12 may also communicate the status of the other beverages indicating that another the amount in the beverage is near the predetermined amount. In this case, the user also can modify the configuration information and request to have both beverages reordered. As a result, the expense of delivery may be reduced since it may be less expense to have two beverages delivered during one transaction than to have two transactions one for each beverage.

Once the user is satisfied with the configuration information, it is sent 114 to the server 14 where it will be subsequently processed. The information can be sent over the communications path 16 using communications technologies discussed above such as over network using wireless techniques. Alternatively, the configuration information also can be sent automatically to the server from the dispenser 12 without user involvement. It should be noted that the user may also have access to the configuration, and if authorized, may change the information such as password data, delivery data, and beverage quantity and type data. As discussed above, the server 14 may communicate the configuration information to a beverage fulfillment service 19 which can actually perform the reorder function including delivering the beverage and configuring the dispenser using the configuration information.

The dispenser 12 receives 116 a configuration information response from the server 14 for configuring the dispenser 12. As discussed above, the response includes information for configuring the dispenser 12. The server may need to retrieve the information which was previously stored in the storage resource 32 such as a file system or database. Once service personnel are at the site of the dispenser, they can communicate with the server 14 over the communications path 16 using, for example, peer-to-peer communications techniques. Alternatively, personnel can download the configuration information from a handheld device using wireless communications techniques such as Bluetooth.

A number of embodiments of the invention have been described. Nevertheless, it will be understood that various modifications may be made without departing from the spirit and scope of the invention. For example, the hardware and software components needed to perform the functions of the server 14 and the beverage fulfillment service 19 can be combined into a single computer system. Accordingly, other embodiments are within the scope of the following claims.

What is claimed is:

1. A method comprising:
receiving beverage consumption information over a communications path;
producing beverage configuration information based on the beverage consumption information, the beverage configuration information to be used for configuring a beverage dispensing device; and
sending the beverage configuration information over the communications path.

2. The method of claim 1, further including:
receiving a beverage configuration information request over the communications path;
retrieving beverage consumption information previously stored; and
sending a beverage configuration information response over the communications path for configuring the beverage dispensing device, wherein the beverage configuration information response is based on the retrieved beverage consumption information.

3. The method of claim 1, wherein the communications path includes a network using wireless communications signals.

4. The method of claim 1, wherein receiving beverage consumption information includes an expected beverage usage during a period of time.

5. The method of claim 1, wherein producing beverage configuration information includes at least one of a beverage quantity, password protection for the beverage as installed in the beverage dispensing device, and beverage delivery information.

6. An apparatus comprising:
a memory for storing beverage consumption information; and
a processor coupled to the memory, wherein the processor is configured to:
receive the beverage consumption information over a communications path,
produce beverage configuration information based on the beverage consumption information, the beverage configuration information to be used to configure a beverage dispensing device, and
send the beverage configuration information over the communications path.

7. The apparatus of claim 6, wherein the processor is further configured to:
receive a beverage configuration information request over the communications path;
retrieve beverage configuration consumption information previously stored; and
send a beverage configuration information response over the communications path, wherein the beverage configuration information response is based on the retrieved beverage consumption information which is used for configuring the beverage dispensing device.

8. The apparatus of claim 6, wherein the communications path includes a network using wireless communications signals.

9. The apparatus of claim 6, wherein the processor is further configured to receive beverage consumption information including an expected beverage usage during a period of time.

10. The apparatus of claim 6, wherein the processor is further configured to produce beverage configuration information including at least one of a beverage quantity, password protection for the beverage as installed in the beverage dispensing device, and beverage delivery information.

11. An article comprising a computer-readable medium that stores computer-executable instructions for causing a computer system to:
receive the beverage consumption information over a communications path;
produce beverage configuration information based on the beverage consumption information, the beverage configuration information to be used to configure a beverage dispensing device; and
send the beverage configuration information over the communications path.

12. The article of claim 11, further including computer-executable instructions for causing a computer system to:
receive a beverage configuration information request over the communications path;
retrieve beverage configuration consumption information previously stored; and
send a beverage configuration information response over the communications path, wherein the beverage configuration information response is based on the retrieved beverage consumption information which is used for configuring the beverage dispensing system

13. The article of claim 11, further including computer executable instructions for causing a computer system to receive a beverage configuration information request over the communications path including a network using wireless communications signals.

14. The article of claim 11, further including computer executable instructions for causing a computer system to receive beverage consumption information including an expected beverage usage during a period of time.

15. The article of claim 11, further including computer executable instructions for causing a computer system to produce beverage configuration information including at least one of a beverage quantity, password protection for the beverage as installed in the beverage dispensing device, and beverage delivery information.

16. A method comprising:
monitoring usage of a beverage in a beverage dispensing device;
producing a beverage configuration information request in response to having the level of the beverage in the beverage dispensing device reach a predetermined threshold level;
sending the beverage configuration information request over a communications path; and
receiving a beverage configuration information response for configuring the beverage dispensing device.

17. The method of claim 16, wherein sending the beverage configuration information request includes sending the beverage configuration information request as an Email signal to an authorized user of the beverage dispensing device.

18. The method of claim 16, wherein sending the beverage configuration information request includes sending the beverage configuration information request as a wireless signal to an authorized user of the beverage dispensing device.

19. The method of claim 16, wherein sending the beverage configuration information request over a communications path includes a network using wireless communications signals.

20. The method of claim 16, wherein receiving a beverage configuration information response includes a password to control access to a beverage in the beverage dispensing device.

21. The method of claim 16, wherein receiving a beverage configuration information response includes a predetermined threshold level that when reached causes the beverage configuration information request to be produced.

22. The method of claim 16, wherein the beverage configuration information response includes beverage dispensing data.

23. An beverage dispensing device comprising:
a memory for storing a beverage configuration information response; and
a processor coupled to the memory, the processor configured to:
monitor usage of a beverage in a beverage dispensing device,
produce a beverage configuration information request in response to having the level of the beverage in the beverage dispensing device reach a predetermined threshold level,
send the beverage configuration information request over a communications path, and
receive a beverage configuration information response for configuring the beverage dispensing device.

24. The device of claim 23, wherein the processor is configured to send the beverage configuration information request as an Email signal to an authorized user of the beverage dispensing device.

25. The device of claim 23, wherein the processor is configured to send the beverage configuration information request as a wireless signal to an authorized user of the beverage dispensing device.

26. The device of claim 23, wherein the communications path includes a network using wireless communications signals.

27. The device of claim 23, wherein the beverage configuration information response includes a password to control access to a beverage in the beverage dispensing device.

28. The device of claim 23, wherein the beverage configuration information response includes a predetermined threshold level that when reached causes the beverage configuration information request to be produced.

29. The device of claim 23, wherein the beverage configuration information includes beverage dispensing data.

30. An article comprising a computer-readable medium that stores computer-executable instructions for causing a computer system to:
monitor usage of a beverage in a beverage dispensing device;
produce a beverage configuration information request in response to having the level of the beverage in the beverage dispensing device reach a predetermined threshold level;
send the beverage configuration information request over a communications path; and
receive a beverage configuration information response for configuring the beverage dispensing device.

31. The article of claim 30, further including computer executable instructions for causing a computer system to send the beverage configuration information request as an Email signal to an authorized user of the beverage dispensing device.

32. The article of claim 30, further including computer executable instructions for causing a computer system to send the beverage configuration information request as a wireless signal to an authorized user of the beverage dispensing device.

33. The article of claim 30, further including computer executable instructions for causing a computer system to send the beverage configuration information request over a communications path including a network using wireless communications signals.
